(19) United States
(12) Patent Application Publication
(10) Pub. No.: US 2022/0317765 A1
(43) Pub. Date: Oct. 6, 2022

(54) IMAGE GENERATION APPARATUS, IMAGE GENERATION METHOD, AND IMAGE DISPLAYING PROGRAM

(71) Applicant: Sony Interactive Entertainment Inc., Tokyo (JP)

(72) Inventor: Takakazu Ikeda, Tokyo (JP)

(73) Assignee: Sony Interactive Entertainment Inc., Tokyo (JP)

(21) Appl. No.: 17/685,641

(22) Filed: Mar. 3, 2022

(30) Foreign Application Priority Data
Apr. 1, 2021 (JP) 2021-063122

(51) Int. Cl. G06F 3/01; G09G 3/00; A63F 13/212; A63F 13/52

(52) U.S. Cl. CPC G06F 3/012; G09G 3/003; A63F 13/212; A63F 13/52; G09G 2310/08; G09G 2320/0252; G09G 2320/0261; G09G 2354/00; A63F 2300/1012; A63F 2300/66

(57) ABSTRACT

An image generation apparatus includes a time period prediction unit that predicts a delay time period from start of process for image generation to display of a head-mounted display image on a head-mounted display, and an image processing unit that executes a reprojection process on the basis of the predicted delay time period to generate the head-mounted display image.

### CROSS REFERENCE TO RELATED APPLICATION

This application claims the benefit of Japanese Priority Patent Application JP 2021-063122 filed Apr. 1, 2021, the entire contents of which are incorporated herein by reference.

### BACKGROUND

The present disclosure relates to an image generation technology.

A head-mounted display connected to a game machine is usually mounted on a head of a user such that the user operates a controller or the like to play a game, while a screen image displayed on the head-mounted display is watched. In a case where the head-mounted display is mounted on the head, the user does not see any other than a video displayed on the head-mounted display. Therefore, the immersive feeling of the user in the image world is enhanced, and this provides an effect of further increasing an aspect of entertainment. Further, if a virtual reality (VR) image is displayed on the head-mounted display and the user wearing the head-mounted display turns the head, then a virtual space around entire circumference over 360 degrees around the user is displayed. This further increases the immersive feeling of the user in the image and enhances also operability of an application of a game or the like.

In a case where the head-mounted display is provided with a head tracking function in this manner and a VR image is generated while a point of view or the line-of-sight direction is changed in an interlocking relation with a movement (posture) of the head of the user, a delay occurs from the generation to the display of a VR video. Therefore, difference sometimes occurs between the posture of the user supposed at the time of image generation and the posture of the user at a point of time at which the VR image is displayed on the head-mounted display. As a result, the user sometimes feels sick (called “VR reality sickness” or the like). Therefore, a reprojection process for correcting the drawn image to an image conforming to the posture at the time of video display is used commonly.

### SUMMARY

In order to provide an image using a head-mounted display, various image generation systems having different performances have been developed. Together with such development, a technology for more appropriately setting a delay time period from the generation to the display of an image according to an image generation system to be used and applying the delay time period to a reprojection process is demanded.

Taking the foregoing situation, it is desirable to provide a technology for more appropriately setting a delay time period from the generation to the display of an image according to an image generation system to be used and applying the delay time period to a reprojection process.

According to an aspect of the present disclosure, there is provided an image generation apparatus including a time period prediction unit that predicts a delay time period from start of process for image generation to display of a head-mounted display image on a head-mounted display, and an image processing unit that executes a reprojection process on the basis of the predicted delay time period to generate the head-mounted display image.

It is to be noted that any combination of what are described hereinabove and the components and the representations of the present disclosure are effective as modes of the present disclosure where they are converted between a method, an apparatus, a program, a transitory or non-transitory storage medium in which a program is recorded, a system, and the like.

According to the present disclosure, it is made possible to more appropriately set a delay time period from generation to display of an image according to an image generation system to be used and apply the delay time period to a reprojection process.

### BRIEF DESCRIPTION OF THE DRAWINGS

FIG. 1 is a view depicting an appearance of a head-mounted display;

FIG. 2 is a view depicting a configuration of an image generation system;

FIG. 3 is a block diagram of an image generation apparatus of FIG. 2;

FIG. 4 is a view illustrating a flow of processing from start of processing for image generation to display of a head-mounted display (HMD) image on the HMD; and

FIG. 5 is a flow chart illustrating a flow of processing for image generation by the image generation apparatus.

### DETAILED DESCRIPTION OF THE PREFERRED EMBODIMENT

### Embodiment

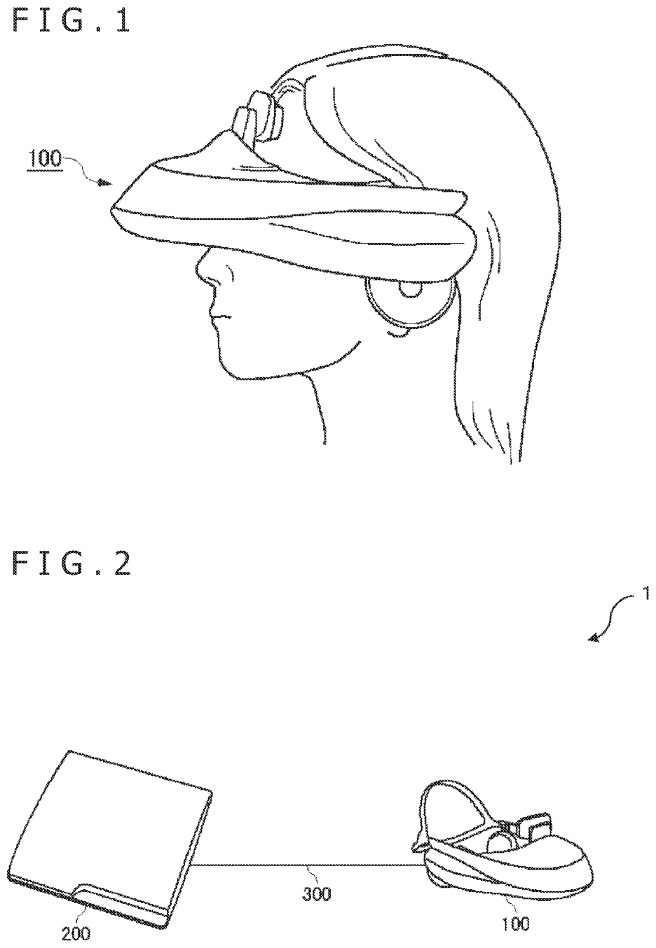

FIG. 1 is a view depicting an appearance of an HMD 100. The HMD 100 is a display device that is mounted on a head of a user and allows the user to appreciate a still picture or a moving picture displayed on the display and enjoy sound, music, or the like outputted from a headphone.

Position information of the head of the user who wears the HMD 100 and posture (orientation) information of the user such as the turning angle and the inclination of the head of the user can be measured by a gyro sensor, an acceleration sensor, and so forth built in or externally connected to the HMD 100.

The HMD 100 may further include a camera for imaging eyes of the user. From the camera implemented in the HMD 100, a gazing direction, a movement of pupils, a blink of the eyes, and so forth of the user can be measured.

The HMD 100 is an example of a “wearable display.” Here, a generation method of an image to be displayed on the HMD 100 is described. It is to be noted that image generation method according to the present embodiment can be applied not only to an HMD in a narrow sense such as the HMD 100 but also to glasses, a glasses-type display, a glasses-type camera, a headphone, a headset (a headphone with a microphone), an earphone, an earring, an ear hook camera, a hat, a hat with a camera, a hear band, or the like to be worn by a user.

FIG. 2 is a view depicting a configuration of an image generation system according to the present embodiment. An image generation system 1 includes the HMD 100 and an image generation apparatus 200. The HMD 100 is connected to the image generation apparatus 200 through an interface such as, for example, High-Definition Multimedia Interface (HDMI) (registered trademark) that is a standard for a communication interface for transmission of a video and sound in a form of a digital signal or DisplayPort that is a standard for an image output interface.

In the present embodiment, a data transmission line 300 between the HMD 100 and the image generation apparatus 200 is an HDMI transmission line or a DisplayPort transmission line. According to the HDMI standard or the DisplayPort standard, a secondary data packet can be transmitted together with an image frame linked thereto, and metadata relating to the frame can be placed into the secondary data packet. In the HDMI 2.1 standard, a function called dynamic high dynamic range (HDR) is available, and it is possible to refer to dynamic metadata of a video to generate a video in which a luminance or a color depth is adjusted optimally for each frame according to a scene. According to the HDMI 2.1 standard, as the dynamic metadata, information necessary for the dynamic HDR such as a maximum luminance, an average luminance, and a minimum luminance can be transmitted in synchronism with a video. The communication interface between the HMD 100 and the image generation apparatus 200 is not limited to HDMI or DisplayPort as long as it can transmit metadata in synchronism with a video.

The image generation apparatus 200 generates predicted position-posture information of the HMD 100 from current position-posture information of the HMD 100 taking a delay from generation to display of an image into consideration. The image generation apparatus 200 draws an image for the HMD 100 (the image is hereinafter referred to as an HMD image) assuming the predicted position-posture information of the HMD 100 and transmits the HMD image to the HMD 100.

The image generation apparatus 200 according to the present embodiment is a game machine. The image generation apparatus 200 may be connected further to a server through a network. In this case, the server may provide an online application of a game or the like in which a plurality of users can participate through the network to the image generation apparatus 200.

Basically, the image generation apparatus 200 processes a program of content and generates and transmits an HMD image to the HMD 100. A program and data of content are read out by a medium drive (not depicted) from a read only memory (ROM) medium (not depicted) in which application software of content of a game or the like and license information are recorded. The ROM medium is a read only recording medium such as an optical disk, a magneto-optical disk, or a Blue-ray disk. In a certain mode, the image generation apparatus 200 specifies a position of a point of view and a direction of a line of sight on the basis of the position and the posture of the head of a user who wears the HMD 100, and generates an HMD image of the content at a predetermined rate such that a field of view corresponding to a specified position and a specified direction is established.

The HMD 100 receives data of an HMD image and displays the data as an image of content. A video to be displayed on the HMD 100 may be, in addition of a video captured in advance by the camera, a video created by computer graphics such as a game video or a live video of a remote place distributed through a network. Further, the image to be displayed on the HMD 100 may be a VR image, an augmented reality (AR) image, a magnetic resonance (MR) image, or the like.

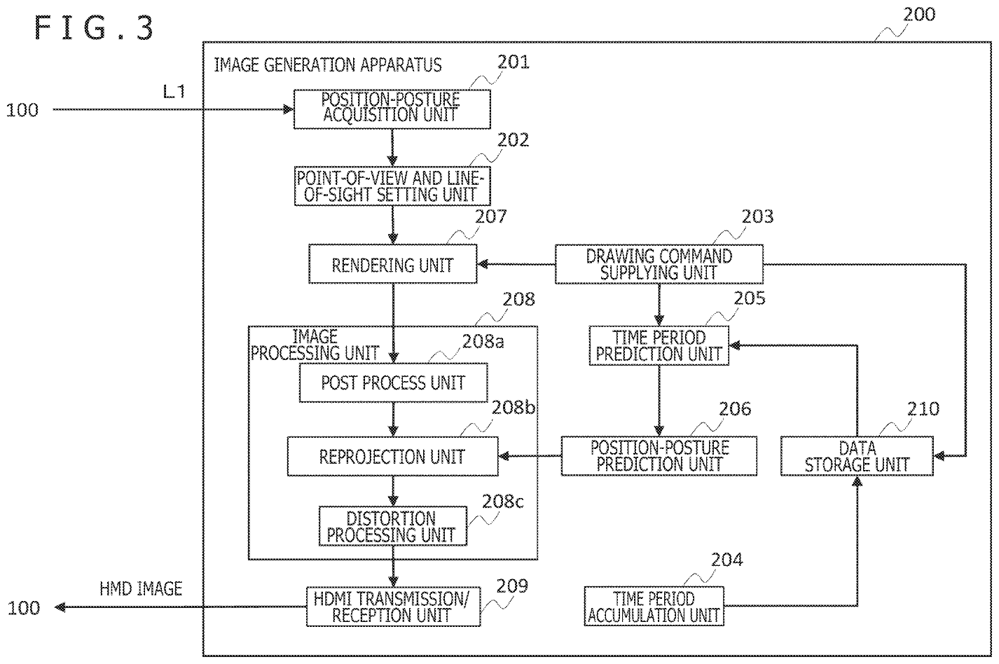

FIG. 3 is a block diagram depicting a functional configuration of the image generation apparatus 200 of FIG. 2. The block diagram of FIG. 3 focuses on functions of the image generation apparatus 200, and the functional blocks depicted can be implemented in various forms from only hardware, from only software, or from a combination of them. The image generation apparatus 200 includes a position-posture acquisition unit 201, a point-of-view and line-of-sight setting unit 202, a drawing command supplying unit 203, a time period accumulation unit 204, a time period prediction unit 205, a position-posture prediction unit 206, a rendering unit 207, an image processing unit 208, an HDMI transmission/reception unit 209, and a data storage unit 210.

At least part of the functions of the image generation apparatus 200 may be implemented otherwise in the HMD 100. Alternatively, at least part of the functions of the image generation apparatus 200 may be implemented in the server connected to the image generation apparatus 200 through the network.

The position-posture acquisition unit 201 acquires current position-posture information L1 of the HMD 100 from the HMD 100.

The point-of-view and line-of-sight setting unit 202 uses the position-posture information L1 of the HMD 100 acquired by the position-posture acquisition unit 201 to set a point-of-view position and a line-of-sight direction of the user.

The drawing command supplying unit 203 generates a drawing command for starting generation of an HMD image. The drawing command supplying unit 203 links frame data of the drawing command to a frame identifier (ID) hereinafter described.

The time period accumulation unit 204 accumulates first and second timestamps relating to individual frame data linked to a same frame ID to calculate a drawing time period hereinafter described and accumulates the drawing time period into the data storage unit 210.

The time period prediction unit 205 predicts a delay time period after processing for image generation is started until an HMD image is displayed on the HMD 100 on the basis of drawing time periods accumulated in the data storage unit 210 and display processing time periods, as hereinafter described.

The position-posture prediction unit 206 predicts an amount of change in a position and a posture during a delay time period predicted by the time period prediction unit 205. The position-posture prediction unit 206 can calculate the amount of change in the position and the posture by multiplying a translation speed or an angular speed of the head of the user who wears the HMD 100 by the delay time period. The position-posture prediction unit 206 adds the amounts of change of the position and the posture during the delay time period to the current position-posture information L1 to generate predicted position-posture information L2 after lapse of the delay time period.

The rendering unit 207 reads out image data necessary for generation of an image from the data storage unit 210 in response to a drawing command and renders an object in a virtual space to generate an image. For example, the rendering unit 207 renders an object in a virtual space, which looks in the line-of-sight direction from the point-of-view position of the user wearing the HMD 100, according to the point-of-view position and the line-of-sight direction of the user set by the point-of-view and line-of-sight setting unit 202, to generate an image. Here, the image data may be a moving-picture or still-picture content created in advance or may be a rendered computer graphics picture. The rendering unit 207 links frame data of the rendered image to a frame ID hereinafter described.

The image processing unit 208 performs an image process as needed for the rendered image to generate an HMD image and provides the HMD image to the HDMI transmission/reception unit 209. The image processing unit 208 includes a post process unit 208a, a reprojection unit 208b, and a distortion processing unit 208c. The image processing unit 208 links the frame data of the HMD image to a frame ID hereinafter described.

The post process unit 208a performs post processes such as depth-of-field adjustment, tone mapping, and antialiasing for an image supplied from the rendering unit 207 such that computer graphics (CGs) image can look natural and smooth.

The reprojection unit 208b receives predicted position-posture information L2 from the position-posture prediction unit 206 and performs a reprojection process for the image for which the post processes have been performed. By the reprojection process, the reprojection unit 208b converts the image for which the post processes have been performed into an image that looks from the point-of-view position and line-of-sight direction according to the delay time period.

The distortion processing unit 208c performs a process for deforming (distortion) and distorting an image for which the reprojection process has been performed, according to distortion that occurs in an optical system of the HMD 100 to distort the image, to generate an HMD image.

The HDMI transmission/reception unit 209 receives the HMD image from the image processing unit 208. The HDMI transmission/reception unit 209 transmits the HMD image to the HMD 100 according to the HDMI.

The data storage unit 210 stores therein data necessary for generation of an image and various programs for executing various processes. The data storage unit 210 stores first and second timestamps hereinafter described in a linked relation to a frame ID. The data storage unit 210 stores a drawing time period and a display processing time period hereinafter described.

Here, time will be spent until, after the posture of the HMD 100 is detected and a next drawing range is determined and then a central processing unit (CPU) issues a drawing command and a graphics processing unit (GPU) executes rendering, a drawn image is outputted to the HMD 100. If it is assumed that the drawing is performed at a frame rate of, for example, 60 fps (frame/second), then even if the CPU operates at a sufficiently high speed, a delay by one frame occurs after turning of the HMD 100 is detected until an image is outputted. This is approximately 16.67 milliseconds under the frame rate of 60 fps and is a sufficient period of time in which a human being detects such offset. Also, when an image drawn by the image generation apparatus 200 is transmitted to the HMD 100 through the data transmission line 300, latency occurs.

Therefore, a reprojection process is performed for the generated image. In the reprojection process, the rendered image is corrected according to a position and a posture of the HMD 100 supposed after lapse of the delay time period such that a human being is less likely to feel the offset.

In the past, the delay time period is set individually according to content of a game or the like by a creator of the content. On the other hand, various image generation systems having different performances from each other are developed in order to provide an image using an HMD such as the HMD 100. Between image generation systems having different performances in this manner, the delay time period differs depending upon an HMD such as the HMD 100 and an image generation apparatus such as the image generation apparatus 200. For example, the drawing time period after processing for image generation is started until image processing for a rendered image by an image processing unit is started differs depending upon an HMD such as the HMD 100 and an image generation apparatus such as the image generation apparatus 200. Further, for example, the display processing time period until an HMD image generated by the image generation apparatus 200 is displayed on the HMD 100 differs depending upon the performances of the HMD 100 and the image generation apparatus 200. Therefore, the set delay time period is sometimes inappropriate in a specific image generation system. As a result, an offset occurs between the posture of the user supposed at the time of image generation and the posture of the user at the point of time at which the HMD image is displayed on the HMD 100, and this sometimes puts the user into VR sickness.

In the present embodiment, the delay time period after processing for image generation is started by the image generation apparatus 200 until the HMD image is displayed on the HMD 100 is predicted. The processing for image generation here includes a generation process of a drawing command, a generation process of a rendered image, and a generation process of an HMD image (image process for the rendered image). In the present embodiment, a reprojection process is executed using a delay time period predicted for each image generation system. Accordingly, an offset, which arises from the performance of the image generation system, between the posture of the user assumed at the time of image generation and the posture of the user at the point of time at which the HMD image is displayed can be suppressed. In the following, details are described below.

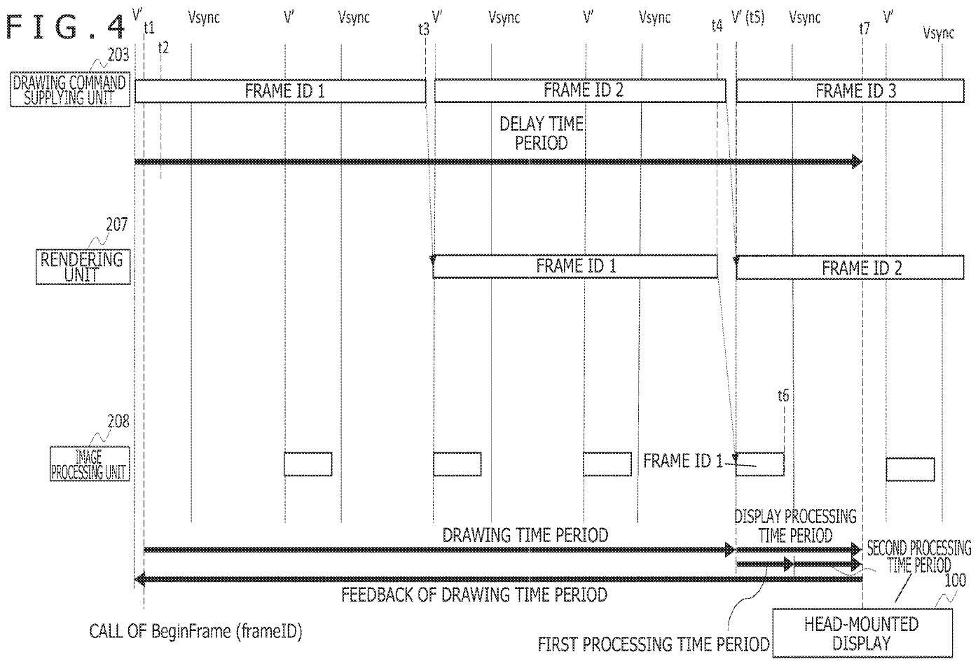

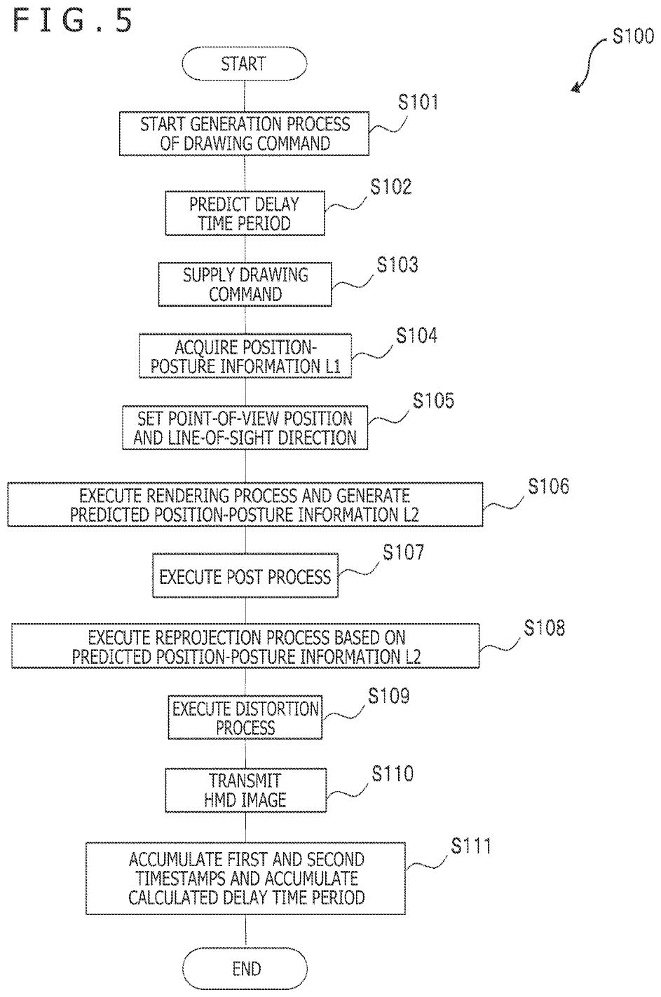

A flow of operations after processing for image generation is started until the HMD image is displayed on the HMD 100 is described with reference to FIG. 4. In FIG. 4, a synchronization timing Vsync indicates a vertical synchronization timing of the display panel of the HMD 100, and a processing timing V′ indicates a timing at which a thread of the processing for image generation goes live.

When the processing timing V′ comes, the CPU calls, at timing t1, an application programming interface (API) for declaring beginFrame( ) using a frame ID 1 as an argument, and the drawing command supplying unit 203 starts a generation process of a drawing command. At this time, the drawing command supplying unit 203 links the frame ID 1 to frame data of the drawing command.

Thereafter, at timing t2, the CPU calls an API for returning a timestamp of the frame data linked to the frame ID 1. At this time, the time period prediction unit 205 predicts a delay time period on the basis of a drawing time period and a display processing time period in the past accumulated in the data storage unit 210 and the synchronization timing Vsync. For example, the time period prediction unit 205 sums the drawing time period and the display processing time period in the past and determines the sum time period as a delay time period. The time period prediction unit 205 supplies the predicted delay time period to the position-posture prediction unit 206.

The drawing time period here is a period of time after the processing for image generation is started until an image process for the rendered image by the image processing unit 208 is started. The drawing time period in the past here is an average value of several optional ones of the drawing time periods accumulated in the data storage unit 210. By adopting the average time period as the drawing time period in the past in this manner, the drawing time periods in the past can be reflected up to a finer value on the prediction time period. It is to be noted that, in a state in which no drawing time period is accumulated in the data storage unit 210 as at first time running, the time period prediction unit 205 predicts the delay time period assuming, for example, that it is 0 and thereafter predicts the delay time period using an accumulated time period or periods.

The display processing time period here is a period of time until an HMD image generated by the image generation apparatus 200 is displayed on the HMD 100. As depicted in FIG. 4, the display processing timing period includes a first processing time period from start time of the generation process of an HMD image to a next synchronization timing Vsync and a second processing time period from this synchronization timing Vsync until the HMD image is displayed on the HMD 100.

The first processing time period is stored, for example, as a value set in advance by the creator side of content of a game or the like, into the data storage unit 210. The first processing time period is set to a suitable value for each content.

The second processing time period is stored as a value unique to the image generation system 1 in the data storage unit 210. The second processing time period is obtained by performing evaluation therefor in advance by the image generation system 1. In the present embodiment, a logical value of the second processing time period obtained by evaluation in regard to a plurality of different image generation systems 1 on the whole is used. This is not restrictive, and instead, a second processing time period calibrated for each one image generation system 1 may be used.

After the generation process of a drawing command is completed at timing t3, the drawing command supplying unit 203 supplies frame data of the drawing command linked to the frame ID 1 to the rendering unit 207. When a processing timing V′ next to timing t3 comes, position-posture information L1 is acquired by the position-posture acquisition unit 201, and a point-of-view position and a line-of-sight direction are set on the basis of the position-posture information L1 by the point-of-view and line-of-sight setting unit 202.

The rendering unit 207 starts a rendering process on the basis of the set point-of-view position and line-of-sight direction. At this time, the rendering unit 207 links the frame ID 1 to the frame data of the rendered image. Meanwhile, the position-posture prediction unit 206 generates predicted position-posture information L2 on the basis of the predicted delay time period and the position-posture information L1.

When the rendering process is completed at timing t4, the rendering unit 207 supplies the frame data of the rendered image linked to the frame ID 1 to the image processing unit 208. Meanwhile, the position-posture prediction unit 206 supplies the predicted position-posture information L2 to the image processing unit 208.

When timing t5 of next processing timing V′ after timing t4 comes, the image processing unit 208 starts a generation process of an HMD image (image process for the rendered image) for performing a post process, a reprojection process, a distortion process, and so forth in regard to the rendered image. Especially, the reprojection unit 208b performs a reprojection process on the basis of the predicted position-posture information L2. At this time, the image processing unit 208 links the frame ID 1 to the frame data of the HMD image.

After the generation process of an HMD image is completed at timing t6, the HDMI transmission/reception unit 209 transmits the HMD image to the HMD 100 according to the HDMI. Consequently, the HMD image is displayed on the HMD 100 at timing t7. It is to be noted that timing t7 is set to an intermediate timing between a synchronization timing Vsync after timing t5 and a next synchronization timing Vsync because it is taken into consideration that display of the HMD image on the HMD 100 is partly completed successively after a certain synchronization timing Vsync and is fully completed at a next synchronization timing Vsync.

After the HMD image is displayed at timing t7, the time period accumulation unit 204 accumulates the first timestamp at the time of start of generation of the drawing command (timestamp of beginFrame( )) into the data storage unit 210 on the basis of the frame ID 1 linked to the frame data of the drawing command. The time period accumulation unit 204 accumulates the second timestamp at the time of the start of the image process by the image processing unit 208 into the data storage unit 210 on the basis of the frame ID 1 linked to the HMD image.

The time period accumulation unit 204 calculates a drawing time period from the time of the start of the generation process of the drawing command to the time of the completion of the generation process of the HMD image on the basis of the first and second timestamps. The time period accumulation unit 204 accumulates the calculated drawing time period into the data storage unit 210. Such accumulated drawing time periods are used in a later process for image generation.

Returning to the time of the completion of the generation process of a drawing command at timing t3, at processing timing V′ next to timing t3, the drawing command supplying unit 203 generates a drawing command in a linked relation to a frame ID 2. At this time, the frame ID 1 is used in a linked relation to a frame of the rendered image in the rendering process. The drawing command supplying unit 203 uses, in the generation process of a drawing command, the frame ID 2 different from the frame ID 1, which is used in the rendering process in a process for different image generation, such that the frame ID does not conflict by an amount at least corresponding to the buffer.

A process S100 for image generation by the image generation apparatus according to the present embodiment is described with reference to FIG. 5.

In step S101, the drawing command supplying unit 203 starts a generation process of a drawing command. At this time, the drawing command supplying unit 203 links the frame ID 1 to frame data of the drawing command and stores the frame ID 1 into the data storage unit 210. After the drawing command supplying unit 203 starts generation of a drawing command, the drawing command supplying unit 203 supplies a prediction instruction to the time period prediction unit 205.

In step S102, the time period prediction unit 205 predicts a delay time period on the basis of a drawing time period and a display processing time period in the past read out from the data storage unit 210 and the synchronization timing Vsync. The time period prediction unit 205 supplies the predicted delay time period to the position-posture prediction unit 206.

After the generation of frame data of the drawing command is completed, at step S103, the drawing command supplying unit 203 supplies the frame data of the drawing command linked to the frame ID 1 to the rendering unit 207.

In step S104, the position-posture acquisition unit 201 acquires position-posture information L1. The position-posture acquisition unit 201 supplies the acquired position-posture information L1 to the point-of-view and line-of-sight setting unit 202 and the position-posture prediction unit 206.

In step S105, the point-of-view and line-of-sight setting unit 202 sets a point-of-view position and a line-of-sight direction on the basis of the position-posture information L1. The point-of-view and line-of-sight setting unit 202 supplies the point-of-view information indicative of the set point-of-view position and line-of-sight direction to the rendering unit 207.

In step S106, the rendering unit 207 executes a rendering process on the basis of the set point-of-view position and line-of-sight direction. At this time, the rendering unit 207 links the frame ID 1 to frame data of a rendered image. The rendering unit 207 supplies the frame data of the rendered image linked to the frame ID 1 to the post process unit 208a of the image processing unit 208. Further, the position-posture prediction unit 206 generates predicted position-posture information L2 on the basis of the predicted delay time period and the position-posture information L1 and supplies the predicted position-posture information L2 to the reprojection unit 208b of the image processing unit 208.

In step S107, the post process unit 208a of the image processing unit 208 executes a post process for the rendered image. The post process unit 208a of the image processing unit 208 supplies the image for which the post process has been performed to the reprojection unit 208b.

In step S108, the reprojection unit 208b executes a reprojection process on the basis of the predicted position-posture information L2. Since the predicted position-posture information L2 is generated on the basis of the delay time period, the image for which the reprojection process has been performed reflects the delay time period. The reprojection unit 208b supplies the image for which the reprojection process has been performed to the distortion processing unit 208c.

In step S109, the distortion processing unit 208c executes a distortion process for the image for which the reprojection process has been performed. By the image process at steps S107 to S109 described above, an HMD image is generated. To the HMD image, the frame ID 1 is linked. The distortion processing unit 208c supplies the HMD image linked to the frame ID 1 to the HDMI transmission/reception unit 209.

In step S110, the HDMI transmission/reception unit 209 transmits the HMD image to the HMD 100 according to the HDMI. Consequently, the HMD image is displayed on the HMD 100.

In step S111, the time period accumulation unit 204 accumulates the first and second timestamps into the data storage unit 210 on the basis of the frame ID 1 linked to each frame data. Further, the time period accumulation unit 204 calculates a drawing time period on the basis of the difference between the first and second timestamps. The time period accumulation unit 204 accumulates the calculated drawing time period into the data storage unit 210.

After step S111, the process S100 for image generation is ended.

In the following, working effects according to the present embodiment are described.

In the present embodiment, the reprojection process is executed using a more appropriate delay time period in response to a performance of the image generation system 1. According to the present configuration, an offset in posture of the user between the posture at the time of image generation and the posture at the time of image displaying can be suppressed. As a result, VR sickness of the user can be suppressed.

In the present embodiment, the time period accumulation unit 204 accumulates a drawing time period into the data storage unit 210, and the time period prediction unit 205 predicts a delay time period on the basis of such accumulated drawing time periods. Here, as described above, the drawing time period and the processing time period differ between image generation systems having performances different from each other. According to the present embodiment, the drawing time period of the image generation system 1 is accumulated, and the display processing time period by the image generation system 1 is stored in advance into the data storage unit 210. By using the accumulated drawing time periods and the stored display processing time period in prediction of a delay time period, the delay time period can be predicted with a higher degree of accuracy.

In the present embodiment, the drawing command supplying unit 203, the rendering unit 207, and the image processing unit 208 supply frame data in the individual processes in a linked relation to a frame ID. The time period accumulation unit 204 accumulates the first and second timestamps in the frame data linked to the frame ID into the data storage unit 210. Here, for example, in FIG. 4, the process for image generation corresponding to the frame ID 2 is sometimes completed before the process for image generation corresponding to the frame ID 1. At this time, in a case where a frame ID is not linked to the frame data in the processes, it may not be grasped to which one of the processes for image generation the completed process corresponds. Accordingly, by linking the same frame ID to the individual frame data in the processes for image generation, it becomes possible to distinctly grasp a timing at which the process for the image generation is to be completed.

### (Modifications)

In the following, modifications of the embodiment are described.

Although, in the present embodiment, a delay time period is predicted on the basis of a drawing time period and a display processing time period, this is not restrictive, and a delay time period may be predicted by a different technique. For example, the time period prediction unit 205 calculates a synchronization timing Vsync suitable for display on the HMD 100 on the basis of the drawing time period and calculates a period of time to the synchronization timing Vsync calculated from the start of the process for image generation. The time period prediction unit 205 may determine the period of time that is the sum of the calculated time period and the second processing time period as the delay time period.

Although, in the present embodiment, the drawing time period in the past is an average value of several optional ones of drawing time periods accumulated in the data storage unit 210, this is not restrictive. For example, the drawing time period in the past may be calculated in the following manner. In particular, the time period accumulation unit 204 includes a Vsync counter that increments its count value for each synchronization timing Vsync (for example, increments the count value by 1). The time period accumulation unit 204 checks the count value of the Vsync counter at a timing at which beginFrame(frameId) is called. The time period accumulation unit 204 checks the count value of the Vsync counter again at a timing at which a generation process of an HMD image relating to a frame ID same as the frame ID used in beginFrame(frameId) is started. The time period accumulation unit 204 calculates a count value from the start of processing for image generation to the start of the generation process of an HMD image on the basis of the difference between the count values and accumulates the calculated count value into the data storage unit 210. The time period accumulation unit 204 takes a majority vote on the count value in several ones of the drawing time periods in the past accumulated in the data storage unit 210. The time period accumulation unit 204 calculates a drawing time period on the basis of the count value obtained as a result of the majority vote and accumulates the drawing time period into the data storage unit 210. In particular, the time period accumulation unit 204 calculates the drawing time period by multiplying a count value obtained as a result of the majority vote by the cycle length of the synchronization timing Vsync (for example, 8.33 ms (120 Hz), 11.11 ms (90 Hz), or the like). The time period prediction unit 205 predicts a delay time period using the calculated drawing time period. According to the present configuration, in a case where the drawing time period is elongated inadvertently, it is possible to cause the prediction time period to be less likely to be influenced by the elongation of the drawing time period. Further, the drawing time period in the past may be, for example, the latest value, the median, or the like of the drawing time periods accumulated in the data storage unit 210.

Although, in the present embodiment, a frame ID is linked to each frame data in the process for image generation, this is not restrictive, and a frame ID may not be linked to each frame data.

Although, in the present embodiment, a reprojection process is performed for a rendered image on the basis of predicted position-posture information, this is not restrictive. For example, the reprojection process may be executed by rendering an image on the basis of predicted position-posture information.

Although, in the present embodiment, an HMD image is transmitted according to the HDMI, this is not restrictive, and an HMD image may be transmitted by wireless communication.

The present disclosure has been described in connection with the embodiment. The embodiment is exemplary, and it is recognized by those skilled in the art that various modifications are possible in combination of the components and the processes of the embodiment and that also such modifications fall within the scope and the spirit according to the present disclosure.

1. An image generation apparatus, comprising:
a time period prediction unit that predicts a delay time period from start of process for image generation to display of a head-mounted display image on a head-mounted display; and
an image processing unit that executes a reprojection process on a basis of the predicted delay time period to generate the head-mounted display image.

2. The image generation apparatus according to claim 1, further comprising:
a posture information acquisition unit that acquires posture information indicative of a posture of the head-mounted display at present;
a rendering unit that renders an image on a basis of the posture information and supplies the rendered image to the image processing unit; and
a time period accumulation unit that accumulates a drawing time period after the process for image generation is started until an image process for the rendered image is started by the image processing unit, wherein
the data storage unit has stored therein in advance a display processing time period after the head-mounted display image is generated until the head-mounted display image is displayed on the head-mounted display, and
the time period prediction unit predicts the delay time period on a basis of the accumulated drawing time periods and the display processing time period.

3. The image generation apparatus according to claim 2, wherein the time period prediction unit predicts the delay time period on a basis of an average value of several ones of the drawing time periods accumulated in the data storage unit.

4. The image generation apparatus according to claim 2, wherein
the time period accumulation unit includes a counter that increments a count value thereof for each vertical synchronization timing of the head-mounted display, and
the time period accumulation unit accumulates the drawing time period calculated on a basis of the count value after the processing for image generation is started until an image process for the rendered image is started into the data storage unit.

5. The image generation apparatus according to claim 2, further comprising:
a posture prediction unit that generates predicted posture information indicative of a result of prediction of a posture of the head-mounted display after lapse of the predicted delay time period from the present point of time, on a basis of the posture information and the predicted delay time period, wherein
the image processing unit generates the head-mounted display image by performing a reprojection process for the rendered image on a basis of the predicted posture information.

6. The image generation apparatus according to claim 5, further comprising:
a drawing command supplying unit that links a frame identifier to frame data of a drawing command for starting generation of the head-mounted display image and supplies the frame data linked to the frame identifier to the rendering unit, wherein
the rendering unit starts a rendering process in response to the drawing command and supplies frame data of the rendered image in a linked relation to the frame identifier to the image processing unit,
the image processing unit links the frame identifier to the frame data of the head-mounted display image, and
the time period accumulation unit accumulates the drawing time period into the data storage unit, the drawing time period being calculated on a basis of a timestamp at a time of the start of generation of the drawing command in the frame data of the drawing command and a timestamp at a time of the start of the image process by the image processing unit, both of the timestamps being linked to the frame identifier.

7. The image generation apparatus according to claim 6, wherein the drawing command supplying unit links, in a process for a subsequent image different from the process for the image, a frame identifier different from the frame identifier linked to the frame data for which the process for the image is executed to the drawing command.

8. An image generation method, comprising:
predicting a delay time period from start of process for image generation to display of a head-mounted display image on a head-mounted display; and
executing a reprojection process on a basis of the predicted delay time period to generate the head-mounted display image.

9. A non-transitory, computer readable storage medium containing a computer, which when executed by a computer, causes the computer to perform an image generation method by carrying out actions, comprising:
predicting a delay time period from start of process for image generation to display of a head-mounted display image on a head-mounted display; and
executing a reprojection process on a basis of the predicted delay time period to generate the head-mounted display image.
